(19) United States
(12) Patent Application Publication
(10) Pub. No.: US 2025/0254542 A1
(43) Pub. Date: Aug. 7, 2025

(54) METHODS AND APPARATUSES FOR TRANSMITTING NEURAL NETWORK PARAMETERS FOR ARTIFICIAL INTELLIGENCE OR MACHINE LEARNING MODEL TRAINING

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA)

(21) Appl. No.: 19/189,560

(22) Filed: Apr. 25, 2025

Related U.S. Application Data
(63) Continuation of application No. PCT/CN2022/136777, filed on Dec. 6, 2022.

(51) Int. Cl. H04W 24/02; G06N 3/0495

(52) U.S. Cl. CPC H04W 24/02; G06N 3/0495

(57) ABSTRACT

Aspects of the present disclosure provide methods and apparatuses for transmitting neural network (NN) parameters for artificial intelligence or machine learning (AI/ML) model training in a wireless communication network to reduce overhead and delays for AI/ML model training processes. A base station (BS) may transmit, to a user equipment (UE), information indicative of a sparsification configuration for one or more layers of a NN. The sparsification configuration may be indicative of whether sparsification is enabled for a respective layer and/or for each neuron in the respective layer, whether the neuron is connected or disconnected to another neuron in another layer of the NN. The UE may transmit, to the BS, one or more NN parameters associated with one or more connected neurons according to the sparsification configuration. In some embodiments, the sparsification configuration may be configured or determined by the BS.

### CROSS-REFERENCE TO RELATED APPLICATIONS

This application is a continuation of PCT Application No. PCT/CN2022/136777, entitled “METHODS AND APPARATUSES FOR TRANSMITTING NEURAL NETWORK PARAMETERS FOR ARTIFICIAL INTELLIGENCE OR MACHINE LEARNING MODEL TRAINING,” filed on Dec. 6, 2022, which application is hereby incorporated herein by reference in its entirety.

### TECHNICAL FIELD

The present disclosure relates to wireless communication generally, and, in particular embodiments, to methods and apparatuses for transmitting neural network (NN) parameters for artificial intelligence or machine learning (AI/ML) model training.

### BACKGROUND

Artificial Intelligence technologies may be applied in communication, including AI-based communication in the physical layer and/or AI-based communication in the medium access control (MAC) layer. For example, in the physical layer, the AI-based communication may aim to optimize component design and/or improve the algorithm performance. For the MAC layer, the AI-based communication may aim to utilize the AI capability for learning, prediction, and/or making a decision to solve a complicated optimization problem with possible better strategy and/or optimal solution, e.g., to optimize the functionality in the MAC layer.

In some implementations, an AI architecture in a wireless communication network may involve multiple nodes, where the multiple nodes may possibly be organized in one of two modes, i.e., centralized and distributed, both of which may be deployed in an access network, a core network, or an edge computing system or third party network. A centralized training and computing architecture may be restricted by possibly large communication overhead and strict user data privacy. A distributed training and computing architecture may comprise several frameworks, e.g., distributed machine learning and federated learning.

Federated learning, which is also known as collaborative learning, is a machine learning technique that trains an algorithm across multiple decentralized edge devices or servers. Each decentralized edge device or server holds local data samples but may not exchange with other devices or servers. The federated learning technique is opposite to traditional centralized machine learning techniques in that local data samples are not shared in the federated learning technique whereas all local datasets are uploaded to one server in traditional centralized machine learning techniques.

In wireless federated learning-based (FL-based) artificial intelligence or machine learning (AI/ML) training processes, a network node/device initializes a global AI/ML model, samples a group of user devices, and broadcasts the global AI/ML model parameters to the user devices. Each user device then initializes its local AI/ML model using the global AI/ML model parameters, and updates (trains) its local AI/ML model using its own data. Each user device may then report its updated local AI/ML model's parameters to the network device, which then aggregates the updated parameters reported by the user devices and updates the global AI/ML model. The aforementioned procedure is one iteration of a conventional FL-based AI/ML model training procedure. The network device and the participating user devices typically perform multiple iterations until the AI/ML model has converged sufficiently to satisfy one or more training goals/criteria and the AI/ML model is finalized.

However, the conventional FL-based AI/ML model training processes have some critical issues. For example, as shown in FIG. 1A, each of user devices 20, 22, 24, and 26 may transmit their local AI/ML model to a network device 30 in a wireless network 10. Each of the user devices 20, 22, 24, and 26 updates (trains) its local AI/ML model and reports its updated local AI/ML model's parameters to the network device 30. The neural network (NN) structure of each transmitted AI/ML model may be same as that of a global AI/ML model. Given that the global AI/ML model has a large number of parameters, reporting updated local AI/ML model parameters may cause huge uplink (UL) communication overhead in the network during the FL-based AI/ML model training procedure.

There exists another problem in the conventional FL-based AI/ML model training procedure. Particularly in synchronous FL-based AI/ML model training, a network device updates global AI/ML model, for example aggregates and averages parameters reported by the user devices, after receiving the local AI/ML model's parameters from all user devices participating in the FL-based AI/ML model training.

Example training delays occurring in a conventional FL-based AI/ML model training procedure is illustrated in FIG. 1B. In FIG. 1B, four user devices 20, 22, 24, and 26 are user devices that are participating in FL-based AI/ML model training. Delays 20d, 20u, 22d, 22u, 24d, 24u, 26d, and 26u are communication delays in FL-based AI/ML model training. The delays 20d, 22d, 24d, are 26d are downlink (DL) transmission delays between user devices 20, 22, 24, and 26 and a network device (e.g., network device 30 in FIG. 1A). The DL transmission delays 20d, 22d, 24d, and 26d may include DL transmission delay, DL retransmission delay, DL signal processing delay, etc. The delays 20u, 22u, 24u, are 26u are uplink (UL) transmission delays between the user devices 20, 22, 24, and 26 and the network device. The UL transmission delays 20u, 22u, 24u, and 26u may include UL transmission delay, UL retransmission delay, UL signal processing delay, etc. Delays 20c, 22c, 24c, and 26c are AI/ML processing delays or computation delays at the user device side, e.g., delays for local AI/ML model update at the user devices 20, 22, 24, and 26. Delays 30c and 30c′ are AI/ML processing delays or computation delays at network device side, e.g., delays for global AI/ML model update according to parameters received from the user devices 20, 22, 24, and 26.

As shown in FIG. 1B, the main problem of the conventional FL-based AI/ML model training procedure is that the training delay is determined based on the delay caused by poorly performing user devices (e.g., low channel quality, poor computation capability, etc.). In FIG. 1B, as performance of the user device 26 is the worst, the training delay is determined based on the delay caused by the user device 26. This is because the network device (not shown in FIG. 1B) may not start the next iteration of the AI/ML model training (as indicated by the delay 30c′) until all of the user devices 20, 22, 24, and 26 successfully decode DL transmissions and update their local AI/ML models, and the network device receives updated local AI/ML model parameters from all of the participating user devices 20, 22, 24, and 26. Therefore, the training delay is determined based on the longest communication and processing delay caused by the user device with the worst performance. This may result in a very large delay in the AI/ML model training process.

For these and other reasons, new protocols and signaling mechanisms for AI/ML model training are desired so that new AI-enabled applications and processes can be implemented while minimizing signaling and communication overhead and delays associated with existing AI training procedures.

### SUMMARY

There are limitations in conventional federated learning-based (FL-based) AI training processes. For example, as stated above, reporting updated local AI/ML model parameters may cause huge uplink (UL) communication overhead in the network. Furthermore, the training delay of the AI/ML model training may be determined based on the longest communication and processing delay caused by the user device with the worst performance (e.g., poor channel quality and little computing capability).

One possible way to overcome the aforementioned limitations may be reducing the computation overhead, reducing size of the local AI/ML model parameters or neural network (NN) parameters to be transmitted, or both.

Aspects of the present disclosure provide solutions to overcome the aforementioned limitations, for example specific methods and apparatuses for transmitting NN parameters for AI/ML model training in a wireless communication network.

According to a first broad aspect of the present disclosure, there is provided herein a method for transmitting neural network (NN) parameters for artificial intelligence or machine learning (AI/ML) in a wireless communication network. The method according to the first broad aspect of the present disclosure may include receiving, by a user equipment (UE) from a base station (BS), information indicative of a sparsification configuration for one or more layers of a NN, the sparsification configuration indicative of at least one of: whether sparsification is enabled for a respective layer, or for each neuron in the respective layer, whether the neuron is connected or disconnected to another neuron in another layer of the NN. The method according to the first broad aspect of the present disclosure may further include transmitting, by the UE to the BS, one or more NN parameters associated with one or more connected neurons according to the sparsification configuration.

In some embodiments of the method according to the first broad aspect of the present disclosure, the other layer is a neighbour layer adjacent to the respective layer.

In some embodiments of the method according to the first broad aspect of the present disclosure, the respective layer includes one or more neuron groups, each neuron group comprising a set of consecutive neurons determined based on a keep interval (KI) indicative of the number of the consecutive neurons in the neuron group, each neuron group including only one connected neuron, the KI and the only one connected neuron in each group being included in the sparsification configuration. In some embodiments of the method according to the first broad aspect of the present disclosure, the KI is indicated to the UE through a UE-specific signaling specific to the UE, a group-specific signaling specific to a group of UEs to which the UE belongs, or a cell-specific signaling specific to a cell associated with the UE. In some embodiments of the method according to the first broad aspect of the present disclosure, a location of the only one connected neuron in each neuron group is the same. In some embodiments of the method according to the first broad aspect of the present disclosure, a location of the only one connected neuron in each neuron group is different. In some embodiments of the method according to the first broad aspect of the present disclosure, the only one connected neuron is indicated by an index, the index indicative of at least one of: the location of the only one connected neuron within each neuron group; or whether sparsification is enabled for the respective layer. In some embodiments of the method according to the first broad aspect of the present disclosure, a range for an available value of the index is determined based on the KI.

In some embodiments of the method according to the first broad aspect of the present disclosure, the one or more connected neurons are non-uniformly distributed in at least one of the one or more layers.

In some embodiments of the method according to the first broad aspect of the present disclosure, the one or more layers exclude at least one of an input layer of the NN or output layer of the NN. In some embodiments of the method according to the first broad aspect of the present disclosure, the one or more layers further exclude at least one layer of the NN comprising at least one neuron disconnected from at least one neuron of adjacent layers.

In some embodiments, the method according to the first broad aspect of the present disclosure may further include performing, by the UE, the AI/ML model training using the NN to obtain the one or more NN parameters. In some embodiments of the method according to the first broad aspect of the present disclosure, performing the AI/ML model training includes: receiving, by the UE from the BS, a global AI/ML model; and training, by the UE, the received global local AI/ML model using a local AI/ML model training dataset. In some embodiments of the method according to the first broad aspect of the present disclosure, performing the AI/ML model training includes: receiving, by the UE from the BS, a global AI/ML model; and training, by the UE, a local AI/ML model using a local AI/ML model training dataset, wherein a NN structure of the local AI/ML model is same as a NN structure of the received global AI/ML model.

In some embodiments, the method according to the first broad aspect of the present disclosure may further include configuring, by the UE, the NN based on the sparsification configuration; and performing, by the UE, the AI/ML model training using the configured NN and using a local AI/ML model training dataset to obtain the one or more NN parameters. In some embodiments of the method according to the first broad aspect of the present disclosure, configuring the NN includes: receiving, by the UE from the BS, a global AI/ML model; and generating, by the UE, a local AI/ML model using the sparsification configuration and the received global AI/ML model. In some embodiments of the method according to the first broad aspect of the present disclosure, performing the AI/ML model training includes: training, by the UE, the generated local AI/ML model using a local AI/ML model training dataset, wherein a NN structure of the generated local AI/ML model is different from a NN structure of the received global AI/ML model.

In some embodiments of the method according to the first broad aspect of the present disclosure, the sparsification configuration is further indicative of: one or more iterations of the AI/ML model training associated with the sparsification configuration.

In some embodiments of the method according to the first broad aspect of the present disclosure, the AI/ML model training includes multiple iterations and the sparsification configuration includes a sparsification configuration pattern, the sparsification configuration pattern indicative of a respective sparsification configuration associated with one or more iterations of the AI/ML model training. In some embodiments of the method according to the first broad aspect of the present disclosure, the sparsification configuration pattern is a cyclic repetition of a sequence of multiple sparsification configurations.

According to a second broad aspect of the present disclosure, there is provided herein a method for receiving neural network (NN) parameters for artificial intelligence or machine learning (AI/ML) model training in a wireless communication network. The method according to the second broad aspect of the present disclosure may include transmitting, by a base station (BS) to a user equipment (UE), information indicative of a sparsification configuration for at least one layer of a NN, the sparsification configuration indicative of at least one of: whether sparsification is enabled for a respective layer, or for each neuron in the respective layer, whether the neuron is connected or disconnected to another neuron in another layer of the NN. The method according to the second broad aspect of the present disclosure may further include receiving, by the BS from the UE, one or more NN parameters associated with one or more connected neurons according to the sparsification configuration.

In some embodiments of the method according to the second broad aspect of the present disclosure, the other layer is a neighbour layer adjacent to the respective layer.

In some embodiments, the method according to the second broad aspect of the present disclosure may further include determining, by the BS, the sparsification configuration. In some embodiments of the method according to the second broad aspect of the present disclosure, the BS determines the sparsification configuration based on at least one of computing capability of the UE or uplink (UL) channel quality, and the information indicative of the sparsification configuration is transmitted using a downlink control information (DCI) signaling, a media access control-control element (MAC-CE) signaling, or a radio resource control (RRC) signaling. In some embodiments of the method according to the second broad aspect of the present disclosure, the BS determines the sparsification configuration based on at least one of: a scheduled modulation and coding scheme (MCS), the number of scheduled resource blocks, the number of scheduled layers, a carrier frequency, or a channel quality indicator (CQI) reported by the UE.

In some embodiments of the method according to the second broad aspect of the present disclosure, the respective layer includes one or more neuron groups, each neuron group comprising a set of consecutive neurons determined based on a keep interval (KI) indicative of the number of the consecutive neurons in the neuron group, each neuron group including only one connected neuron, the KI and the only one connected neuron in each group being included in the sparsification configuration. In some embodiments of the method according to the second broad aspect of the present disclosure, the KI is indicated to the UE through a UE-specific signaling specific to the UE, a group-specific signaling specific to a group of UEs to which the UE belongs, or a cell-specific signaling specific to a cell associated with the UE. In some embodiments of the method according to the second broad aspect of the present disclosure, a location of the only one connected neuron in each neuron group is the same. In some embodiments of the method according to the second broad aspect of the present disclosure, a location of the only one connected neuron in each neuron group is different. In some embodiments of the method according to the second broad aspect of the present disclosure, the only one connected neuron is indicated by an index, the index indicative of at least one of: the location of the only one connected neuron within each neuron group; or whether sparsification is enabled for the respective layer. In some embodiments of the method according to the second broad aspect of the present disclosure, a range for an available value of the index is determined based on the KI.

In some embodiments of the method according to the second broad aspect of the present disclosure, the one or more connected neurons are non-uniformly distributed in at least one of the one or more layers.

In some embodiments of the method according to the second broad aspect of the present disclosure, the one or more layers exclude at least one of an input layer of the NN or output layer of the NN. In some embodiments of the method according to the second broad aspect of the present disclosure, the one or more layers further exclude at least one layer of the NN comprising at least one neuron disconnected from at least one neuron of adjacent layers.

In some embodiments of the method according to the second broad aspect of the present disclosure, the sparsification configuration is further indicative of: one or more iterations of the AI/ML model training associated with the sparsification configuration.

In some embodiments of the method according to the second broad aspect of the present disclosure, the AI/ML model training includes multiple iterations and the sparsification configuration includes a sparsification configuration pattern, the sparsification configuration pattern indicative of a respective sparsification configuration associated with one or more iterations of the AI/ML model training. In some embodiments of the method according to the second broad aspect of the present disclosure, the sparsification configuration pattern is a cyclic repetition of a sequence of multiple sparsification configurations.

Corresponding devices are disclosed for performing the methods.

For example, according to another aspect of the disclosure, a user equipment (UE) is provided that includes a processor and a memory storing processor-executable instructions that, when executed, cause the processor to carry out a method according to the first broad aspect of the present disclosure described above. In another example, according to another aspect of the disclosure, a base station (BS) is provided that includes a processor and a memory storing processor-executable instructions that, when executed, cause the processor to carry out a method according to the second broad aspect of the present disclosure described above.

According to other aspects of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

By virtue of some aspects of the present disclosure, AI/ML processing delays or computation delays in AI/ML model training processes (e.g., FL-based AI/ML model training processes) may be reduced, as a reduced number of NN parameters may be trained by a UE according to a sparsification configuration, for example compared to the conventional FL-based AI/ML model training processes.

By virtue of some aspects of the present disclosure, UL transmission overhead and computation or processing delays in AI/ML model training processes (e.g., FL-based AI/ML model training processes) may be reduced, as a reduced NN parameters trained/updated by a UE may be transmitted to a BS according to a sparsification configuration, for example compared to the conventional FL-based AI/ML model training processes.

By virtue of some aspects of the present disclosure, air interface overhead and delays in AI/ML model training processes (e.g., FL-based AI/ML model training processes) may be reduced without degrading AI/ML model inference performance (e.g., accuracy).

### BRIEF DESCRIPTION OF THE DRAWINGS

Reference will now be made, by way of example only, to the accompanying drawings which show example embodiments of the present application, and in which:

FIG. 1A illustrates communication overhead occurring in a conventional wireless federated learning-based (FL-based) artificial intelligence or machine learning (AI/ML) model training procedure;

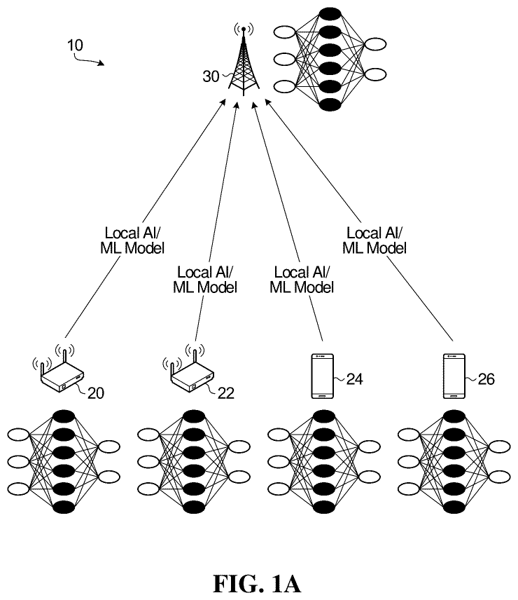

FIG. 1B illustrates training delays occurring in a conventional wireless FL-based AI/ML model training procedure;

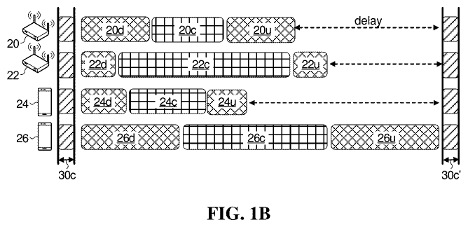

FIG. 2A is a simplified schematic illustration of a communication system, according to one example;

FIG. 2B illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates four EDs communicating with a network device in a communication system, according to embodiments of the present disclosure;

FIG. 6A illustrates and example of a neural network with multiple layers of neurons, according to embodiments of the present disclosure;

FIG. 6B illustrates an example of a neuron that may be used as a building block for a neural network, according to embodiments of the present disclosure;

FIG. 7 illustrates an example of how each neuron in a neuron network (NN) layer may be indexed, in accordance with embodiments of the present disclosure;

FIG. 8 illustrates examples of uniform sparsification configurations indicative of locations of connected neurons in each neuron group, in accordance with embodiments of the present disclosure;

FIG. 9 illustrates an example procedure for transmitting NN parameters for AI/ML model training in a wireless communication network, in accordance with embodiments of the present disclosure;

FIG. 10 illustrates an example for generating a sub-AI/ML model, in accordance with embodiments of the present disclosure; and

FIG. 11 illustrates example sparsification configuration patterns for multiple iterations of an AI/ML model training, in accordance with embodiments of the present disclosure.

Similar reference numerals may have been used in different figures to denote similar components.

### DETAILED DESCRIPTION OF ILLUSTRATIVE EMBODIMENTS

In the present disclosure, “data collection” refers to a process of collecting data by the network nodes, management entity, or user equipment (UE) for the purpose of artificial intelligence (AI)/machine learning (ML) model training, data analytics and inference.

In the present disclosure, “AI/ML Model” refers to a data driven algorithm that applies AI/ML techniques to generate a set of outputs based on a set of inputs.

In the present disclosure, “AI/ML model training” refers to a process to train an AI/ML model by learning the input/output relationship in a data driven manner and obtain the trained AI/ML model for inference.

In the present disclosure, “AI/ML inference” refers to a process of using a trained AI/ML model to produce a set of outputs based on a set of inputs.

In the present disclosure, “AI/ML model validation” refers to a subprocess of training, to evaluate the quality of an AI/ML model using a dataset different from one used for model training, that helps selecting model parameters that generalize beyond the dataset used for model training.

In the present disclosure, “AI/ML model testing” refers to a subprocess of training, to evaluate the performance of a final AI/ML model using a dataset different from one used for model training and validation. Unlike the AI/ML model validation, the AI/ML model testing does not assume subsequent tuning of the model.

In the present disclosure, “On-UE training” refers to online/offline training at the UE.

In the present disclosure, “On-network training” refers to online/offline training at the network.

In the present disclosure, “UE-side (AI/ML) model” refers to an AI/ML model whose inference is performed entirely at the UE.

In the present disclosure, “Network-side (AI/ML) model” refers to an AI/ML model whose inference is performed entirely at the network.

In the present disclosure, “One-sided (AI/ML) model” refers to a UE-side (AI/ML) model or a network-side (AI/ML) model.

In the present disclosure, “Two-sided (AI/ML) model” refers to a paired AI/ML model(s) over which joint inference is performed, where joint inference comprises AI/ML inference whose inference is performed jointly across the UE and the network, i.e., the first part of inference is firstly performed by UE and then the remaining part is performed by gNodeB (gNB), or vice versa.

In the present disclosure, “Model transfer” refers to delivery of an AI/ML model over the air interface, either parameters of a model structure known at the receiving end or a new model with parameters. Delivery may contain a full model or a partial model.

In the present disclosure, “Model download” refers to model transfer from the network to UE.

In the present disclosure, “Model upload” refers to model transfer from UE to the network.

In the present disclosure, “Model deployment” refers to delivery of a fully developed and tested model runtime image to a target UE/gNB where inference is to be performed.

In the present disclosure, “Federated learning/federated training” refers to a machine learning technique that trains an AI/ML model across multiple decentralized edge nodes (e.g., UEs, gNBs) each performing local model training using local data samples. The technique requires multiple model exchanges, but no exchange of local data samples.

In the present disclosure, “Offline field data” refers to data collected from field and used for offline training of the AI/ML model.

In the present disclosure, “Online (field) data” refers to data collected from field and used for online training of the AI/ML model.

In the present disclosure, “Model monitoring” refers to a procedure that monitors the inference performance of the AI/ML model.

In the present disclosure, “Model update” refers to retraining or fine tuning of an AI/ML model, via online/offline training, to improve the model inference performance.

In the present disclosure, “Supervised learning” refers to a process of training a model from input and its corresponding labels.

In the present disclosure, “Unsupervised learning” refers to a process of training a model without labelled data e.g., clustering is a common example of this.

In the present disclosure, “Semi-supervised learning” refers to a process of training a model with a mix of labelled data and unlabeled data.

In the present disclosure, “Reinforcement Learning (RL)” refers to a process of training an AI/ML model from input (e.g., state) and a feedback signal (a.k.a. reward) resulting from the model's output (e.g., action) in an environment the model is interacting with.

In the present disclosure, “AI/ML model delivery” refers to a generic term referring to delivery of an AI/ML model from one entity to another entity in any manner. An entity may be a network node/function (e.g., gNB, LMF, etc.), UE, proprietary server, etc.

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

### Example Communication Systems and Devices

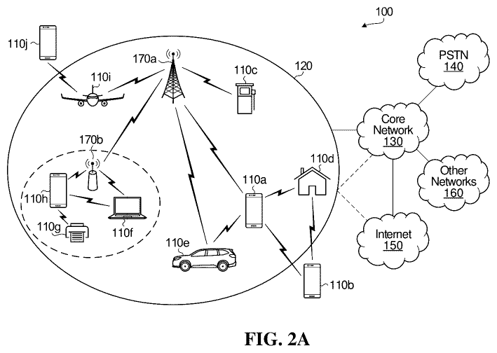

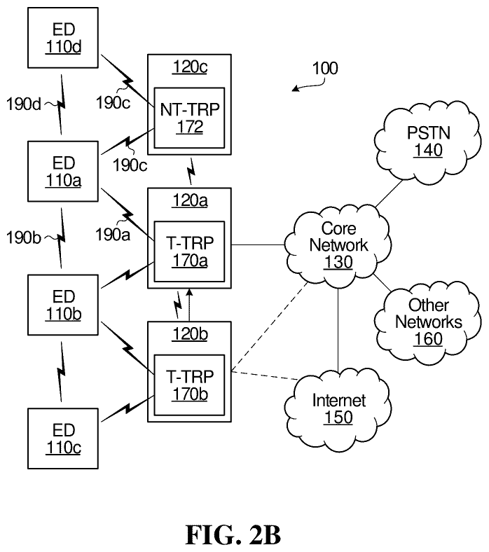

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 2B illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

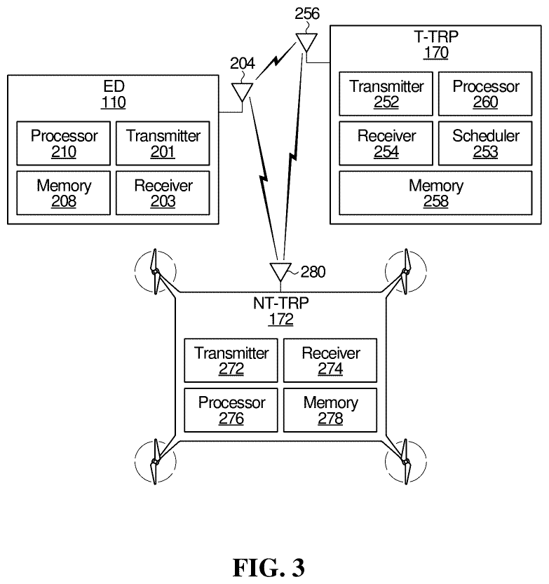

FIG. 3 illustrates another example of an ED 110 and a base station 170. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170 is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

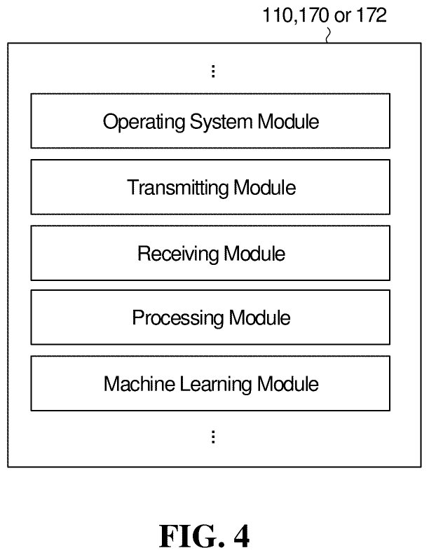

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

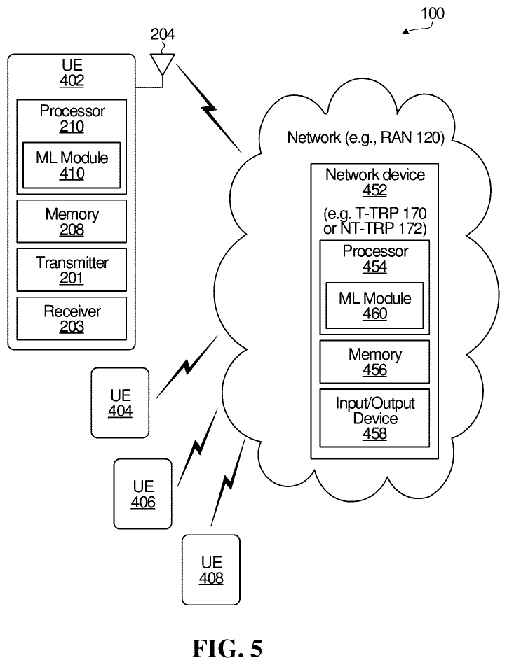

Referring again to FIGS. 2A and 2B, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 452 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

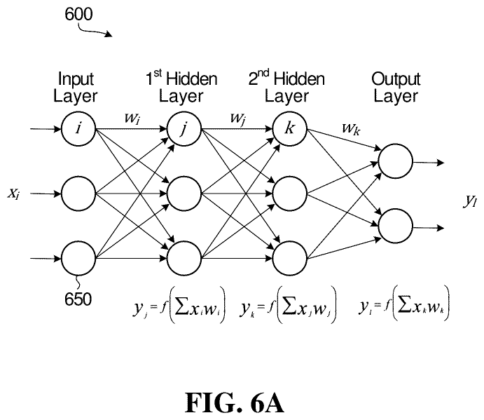

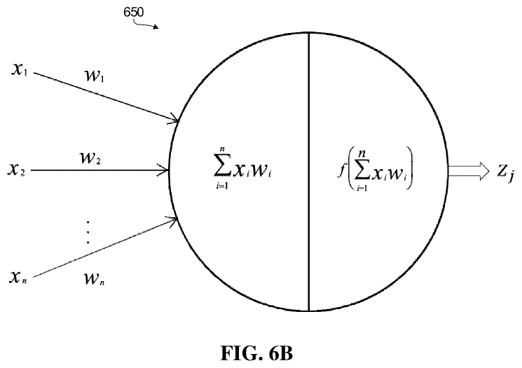

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function ƒ( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

Referring again to FIG. 5, for wireless federated learning (FL), the network device 452 may initialize a global AI/ML model implemented by the ML module 460, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of FL-based AI/ML model training procedure. The network device 452 and the UEs 402, 404, 406 and 408 perform multiple iterations until the AI/ML model has converged sufficiently to satisfy one or more training goals/criteria and the AI/ML model is finalized.

Aspects of the present disclosure provide solutions to overcome at least some of the aforementioned limitations, for example specific methods and apparatuses for transmitting neural network (NN) parameters for artificial intelligence or machine learning (AI/ML) model training in a wireless communication network to reduce overhead and delays for AI/ML model training processes. As noted above, one way to reduce overhead and delays for AI/ML model training processes may be to minimize communication delays, computation delays, or both. These delays may be reduced by utilizing only some of the NN parameters during the AI/ML model training procedure, for example transmitting only some of the NN parameters and/or performing AI/ML model training processes with only some of the NN parameters.

According to some embodiments, for each layer of the NN, a user equipment (UE) may train only some NN parameters that are associated with connected neurons (e.g., neuron connected to another neuron in another layer of the NN) in the layer to reduce an AI/ML model training computation delay. The UE may transmit only some NN parameters that are associated with connected neurons in the layer to a base station (BS) in order to reduce uplink (UL) transmission overhead and UL communication delays. A sparsification configuration may be used to indicate whether sparsification is enable for a layer and/or for an NN layer, which neurons are connected neurons. The sparsification configuration may be determined or configured for example by a BS.

According to some embodiments, a sparsification configuration may be defined for one or more layers in the NN. The sparsification configuration may be considered a sparsification pattern or a sparsification version (SV) defined for the NN layer. The NN layer may be a fully connected NN layer (e.g., a NN layer where all inputs are connected to all outputs) or a convolutional NN layer or a recurrent NN layer or any type of a hidden NN layer.

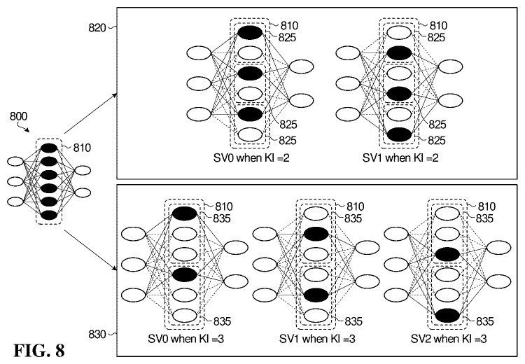

A sparsification configuration may indicate that, for each NN layer, some of neurons in the NN layer may be disconnected, and accordingly connections associated with those disconnected neurons are withdrawn. The sparsification configuration may indicate which neurons are disconnected (e.g., location of disconnected neurons), and therefore further indicate withdrawn connections (i.e., connections associated with disconnected neurons). It may be noted that in some drawings of the present disclosure, for example FIGS. 8, 10-11, circles (or ovals) with solid outlines represent neurons connected to another neuron in another NN layer and solid lines represent connections associated with the connected neurons (e.g., kept connections). Circles (or ovals) with dashed outlines may represent disconnected neurons and dashed lines represent withdrawn connections.

In some embodiments, there may be two types of sparsifications, namely uniform sparsification and non-uniform sparsification. When a NN layer is configured based on a uniform sparsification configuration, connected neurons in the NN layer may be evenly distributed. In other words, when a NN layer is uniformly sparsified, intervals between connected neurons in the NN layer may be the same. When NN layer is configured based on a non-uniform sparsification configuration, one or more connected neurons may be non-uniformly distributed in the NN layer. In other words, when a NN layer is non-uniformly sparsified, intervals between connected neurons in the NN layer may be different from each other.

In some embodiments, a uniform sparsification configuration may be determined, for example by a base station (BS), using a keep interval (KI). The KI may be indicative of the number of consecutive neurons at each neuron group in the NN layer. Each neuron group, which includes a set of consecutive neurons, may include only one connected neuron. In some uniformly sparsified NN layers, connected neurons may be apart from each other by the KI. For example, when the KI is N, a neural node or neuron is kept at an interval of N. Put another way, in some uniformly sparsified layers, a location of the only one connected neuron in each neuron group may be the same. However, in some other uniformly sparsified layers, a location of the only one connected neuron in each neuron group may be different. In any case, there may be only one connected neuron in each neuron group for uniformly sparsified layers. The only one connected neuron in each neuron group and the KI may be included or indicated in the sparsification configuration. The KI may be configurable. The KI may be determined or configured for example by a BS.

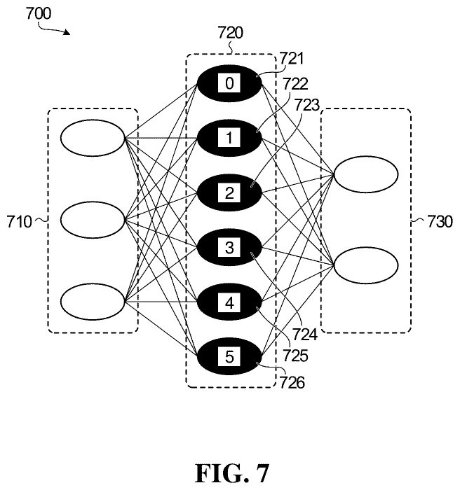

In some embodiments, each neuron in each neuron group may be indicated by an index according to a predetermined manner or a preconfigured rule. In other words, an index may be used to indicate a location of each neuron within the neuron group to which the neuron belongs. For example, neurons may be numbered from 0 to N−1 where K is the total number of neurons in the NN layer from the top to the bottom, as illustrated in FIG. 7. Referring to FIG. 7, the NN 700 includes three layers 710, 720, and 730. In some cases, all of these layers may be hidden layers. In some cases, the layer 710 may be an input layer, the layer 720 may be a hidden layer, and the layer 730 may be an output layer. Each NN layer includes neurons, and each neuron is connected to another neuron in another NN layer. In particular, the hidden NN layer 720 includes six neurons 721 to 726, and each of these neurons 721 to 726 in the NN layer 720 is indexed sequentially from the top to the bottom, as illustrated in FIG. 7. Specifically, the index of the top neuron 721 is 0, the index of the neuron 722 is 1, the index of the neuron 723 is 2, the index of the neuron 724 is 3, the index of the neuron 725 is 4, and the index of the bottom neuron 726 is 5. While the neurons 721 to 726 are indexed sequentially from the top to the bottom in FIG. 7, it should be noted that the neurons 721 to 726 may be indexed in another manner. For example, neurons 721 to 726 may be indexed sequentially from the bottom to the top (i.e., the index of the top neuron 726 is 0, the index of the neuron 725 is 1, the index of the neuron 724 is 2, the index of the neuron 723 is 3, the index of the neuron 722 is 4, and the index of the bottom neuron 721 is 5). Generally speaking, as noted above, the neurons 721 to 726 may be indexed according to a predetermined manner or a preconfigured rule.

The range for an available value of the index may be determined based on the number of neurons in the layer. For example, when the number of neurons is N, the range for available indices may be from 0 to N−1. Therefore, in FIG. 7, the values for the indices for neurons 721 to 726 may be determined based on the number of neurons in the layer 720, specifically from 0 to 5, as there are 6 neurons in the layer 720.

In some embodiments, as noted above, each neuron group, which includes a set of consecutive neurons, may include only one connected neuron. In other words, when KI is N, only one in every N neurons may be connected to another neuron in another layer.

In some embodiments, as noted above, the KI may be indicative of the number of consecutive neurons at each neuron group in the NN layer. The number of neuron groups in the NN layer may be obtained based on the total number of neurons in the NN layer and the KI. For example, when there are M neurons in a NN layer and KI is N, the total number of neuron groups in the NN layer is

$$⌈ \frac{M}{N} ⌉ ,$$

where ┌ ┐ is a ceiling function. When M mod Nis 0, the size of each neuron group (i.e., number of neurons in each neuron group) is always N (where KI=N). When M mod N is not 0, the size of each neuron group (i.e., number of neurons in each neuron group) is N, except one neuron group (generally, one of the first or last neuron group in the NN layer). When M mod N is not 0, the number of neurons in the exception group (e.g., first or last neuron group) is M mod N.

In some embodiments, a sparsification configuration may indicate whether each neuron in a respective NN layer is connected to or disconnected from another neuron in another layer of the NN. Put another way, a sparsification configuration may indicate, for each neuron group, which neuron is connected to another neuron in another NN layer.

In some embodiments, a location of the connected neuron within the neuron group to which said connected neuron belongs may be the same. In such cases, there may be a total of N (when KI=N) sparsification configurations or N sparsification versions (SVs). Each sparsification configuration may be denoted as SV0, SV1, . . . , SVN−1. Given that each sparsification configuration may indicate a location of the connected neuron within the neuron group to which said connected neuron belongs, SV0 may indicate that the first neuron in the neuron group is a connected neuron and other neurons in the neuron group are disconnected neurons. Similarly, SV1 may indicate that the second neuron in the neuron group is a connected neuron and other neurons in the neuron group are disconnected neurons, and SVN−1 may indicate that the Nth neuron in the neuron group is a connected neuron and other neurons in the neuron group are disconnected neurons.

Each uniform sparsification configuration may define a pattern for a location of a connected neuron in each neuron group. Examples of uniform sparsification configurations indicative of locations of connected neurons in each neuron group are illustrated in FIG. 8. Referring to FIG. 8, an AI/ML model 800 is provided. The AI/ML model 800 may include a hidden NN layer 810. The hidden layer 810 may be uniformly sparsified according to one of the uniform sparsification configurations illustrated in FIG. 8.

Within the box 820, two possible uniform sparsification configurations are illustrated when the size of each neuron group is 2 (i.e., KI=2). When KI is 2, the uniform sparsification configuration SV0 may indicate that in each neuron group 825 in the NN layer 810, the first neuron is connected to another neuron in another layer. The uniform sparsification configuration SV1 may indicate that in each neuron group 825 in the NN layer 810, the second neuron is connected to another neuron in another layer.

Within the box 830, three possible uniform sparsification configurations are illustrated when the size of each neuron group is 3 (i.e., KI=3). When KI is 3, the uniform sparsification configuration SV0 may indicate that in each neuron group 835 in the NN layer 810, the first neuron is connected to another neuron in another layer. The uniform sparsification configuration SV1 may indicate that in each neuron group 835 in the NN layer 810, the second neuron is connected to another neuron in another layer. The uniform sparsification configuration SV2 may indicate that in each neuron group 835 in the NN layer 810, the third neuron is connected to another neuron in another layer.

In some embodiments, a location of the only one connected neuron in each neuron group may be not always the same (i.e., same or different). This may be illustrated using a NN layer having 6 neurons. In one example, each neuron group has 2 neurons, and therefore KI for this NN layer is 2. A sparsification configuration for this layer may be determined such that a connected neuron is alternately selected in each neuron group. Specifically, the first neuron is a connected neuron in the first neuron group, but the second neuron is a connected neuron in the second neuron group. In the third neuron group, the first of the two neurons is again a connected neuron in that neuron group.

In some embodiments, for uniform sparsification configuration, a location of a connected neuron in each neuron group may be determined or configured by a base station (BS). In some embodiments, for uniform sparsification configuration, a location of a connected neuron in each neuron group may be predetermined.

In some embodiments, a sub-AI/ML model or a sparse AI/ML model may be defined based on a sparsification configuration and an associated KI (i.e., based on a sparsification configuration and a KI associated with the sparsification configuration). It may be noted that the sparsification configuration may include the associated KI. It may be also noted that each sparsification configuration may indicate a different location for the connected neuron (i.e., a different sparsification configuration may indicate that a different neuron is the connected neuron). In such embodiments, the sub-AI/ML model includes one or more NN layers that are sparsified according to the sparsification configuration and the associated KI (KI may be included in the sparsification configuration). In some embodiments, at least one of the sparsification configuration or KI may be determined or configured, for example, by a BS. In such cases, at least one of the sparsification configuration or KI may indicated, for example to a UE through a UE-specific signaling specific to the UE, a group-specific signaling specific to a group of UEs to which the UE belongs, or a cell-specific signaling specific to a cell associated with the UE. In some embodiments, at least one of the sparsification configuration or KI may be predetermined.

In some embodiments, a sparsification configuration may be determined, for example by a BS, to indicate whether sparsification is enabled for each layer in the NN. For example, when a NN includes Q layers (i.e., one input layer, one output layer, and Q-2 hidden layers), a BS may use a bitmap to indicate whether sparsification is enabled for each NN layer. The bitmap may be of size Q bits and one bitmap bit may be allocated to each NN layer. In other words, the Q bit bitmap may indicate whether sparsification is enabled for all NN layers. Each bitmap bit may indicate whether sparsification is enabled for the associated NN layer using a binary value (i.e., 0 or 1). For example, sparsification is enabled for a certain NN layer when the associated bitmap bit is 1, and sparsification is disabled for a certain NN layer when the associated bitmap bit is 0. A person skilled in the art would readily understand that, alternatively, 0 may be used to indicate that sparsification is enabled for the associated NN layer, and 1 may be used to indicate that sparsification is disabled for the associated NN layer.

In some embodiments, when a NN includes Q layers (i.e., one input layer, one output layer, and Q−2 hidden layers), the sparsification configuration bitmap may be of size Q−2 bits and one bitmap bit may be allocated to each hidden layer. In other words, the Q−2 bit bitmap may indicate whether sparsification is enabled only for Q−2 hidden layers. Each bitmap bit may indicate whether sparsification is enabled for the associated NN layer using a binary value (i.e., 0 or 1) in the same way as illustrated above. When using Q−2 bit bitmaps, sparsification may be disabled for input and output layers by default.

In some embodiments, when a NN includes Q layers (i.e., one input layer, one output layer, and Q−2 hidden layers), a bitmap for sparsification configuration may be used only for a particular type of layers (e.g., fully connected NN layers). For example, when there are X fully connected layers (e.g., NN layers where all inputs are connected to all outputs), the bitmap for sparsification configuration may have a size of X bits. Each bitmap bit may indicate whether sparsification is enabled for the associated fully connected layer using a binary value (i.e., 0 or 1) in the same way as illustrated above. When using X bit bitmaps, sparsification may be disabled for input layer, output layer, and non-fully connected layers.

In some embodiments, a sparsification configuration may be determined, for example by a BS, to indicate whether sparsification is enabled for a respective layer using an index of the respective layer for which sparsification is enabled. The indices included in the sparsification configuration may indicate one or more NN layers for which sparsification is enabled.

In some embodiments, a non-uniform sparsification configuration may be determined, for example by a BS. One or more connected neurons may be non-uniformly distributed in at least one layer of the NN according to the non-uniform sparsification configuration.

In some embodiments, whether sparsification is enabled for each layer may be determined using a kept ratio and a sparsification configuration associated with the kept ratio. The value of kept ratio is configured or determined by a BS (e.g., kept ratio=a) or predetermined.

When there are M neurons in a NN layer and the kept ratio is α, ┌α*M┐ neurons (or └α*M┘ neurons, where └ ┘ is a floor function) may be connected neurons for the non-uniform sparsification configuration associated with that kept ratio (i.e., α). Each non-uniform sparsification configuration may be identified using an index or a certain identifier.

In some embodiments, a BS may configure and indicate in the sparsification configuration which neurons in a respective NN layer are connected neurons. A bitmap may be used to indicate which neurons in a respective NN layer are connected neurons. For example where a layer includes 6 neurons and the associated kept ratio is 0.5, a BS may configure a sparsification configuration (e.g., SV0) using a bitmap “111000”, thereby indicating the first 3 neurons are connected neurons. The BS may configure another sparsification configuration (e.g., SV1) using a bitmap “000111”, thereby indicating the last 3 neurons are connected neurons. In another example where a layer includes 6 neurons and the associated kept ratio α is 0.6, the number of connected neurons for this layer may be ┐0.6*6┌=4. A BS may configure a sparsification configuration (e.g., SV0) using a bitmap “111100”, thereby indicating the first 4 neurons are connected neurons. The BS may configure another sparsification configuration (e.g., SV1) using a bitmap “001111”, thereby indicating the last 4 neurons are connected neurons. It should be noted the number of sparsification configurations associated with a particular kept ratio may be configured by a BS or pre-determined.

In some embodiments, one or more sparsification configurations determined, for example by a BS, may have different associated kept ratios. In such embodiments, each sparsification configuration may be indexed or identified with a number. For example, where a layer includes 6 neurons, a BS may configure a first sparsification configuration (e.g., SV0) using a bitmap “111000” thereby indicating the first 3 neurons are connected neurons, a second sparsification configuration (e.g., SV1) using a bitmap “000111” thereby indicating the last 3 neurons are connected neurons, a third sparsification configuration (e.g., SV2) using a bitmap “111100” thereby indicating the first 4 neurons are connected neurons, and a fourth sparsification configuration (e.g., SV3) using a bitmap “001111” thereby indicating the last 4 neurons are connected neurons.

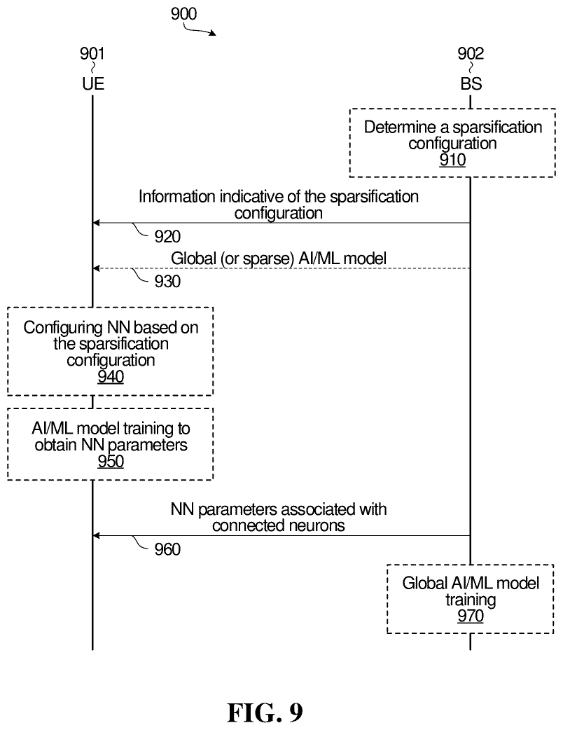

FIG. 9 illustrates an example procedure 900 for transmitting NN parameters for AI/ML model training in a wireless communication network, in accordance with embodiments of the present disclosure. The procedure 900 illustrates one learning iteration for a federated AI/ML model training or other distributed AI/ML model training.

At step 910, a BS 902 may configure or determine a sparsification configuration for at least one layer of a NN. In some embodiments, the BS 902 may determine the sparsification configuration based on at least one of a scheduled modulation and coding scheme (MCS), the number of scheduled resource blocks, the number of scheduled layers, a carrier frequency, or a channel quality indicator (CQI) reported by the UE 901.

The sparsification configuration may indicate at least one of whether sparsification is enabled for a respective layer, or for each neuron in the respective layer, whether the neuron is connected or disconnected to another neuron in another layer of the NN. In some embodiments, the other layer may be a neighbour layer adjacent to the respective layer.

In some embodiments, a sparsification configuration may indicate whether sparsification is enabled for a respective layer in the NN. In some embodiments, the NN may include Q layers including one input layer, one output layer, and Q-2 hidden layers. In some embodiments, the BS 910 may use a bitmap to indicate whether sparsification is enabled for the respective layer in the same way as illustrated above or elsewhere in the present disclosure.

In some embodiments, the BS 902 may indicate whether sparsification is enabled for the respective layer using an index (e.g., index assigned to the respective layer).

In some embodiments, the sparsification configuration may indicate for each neuron in the respective layer, whether the neuron is connected or disconnected to another neuron in another layer of the NN in the same way as illustrated above or elsewhere in the present disclosure.

In some embodiments, the BS 902 may configure or determine more than one sparsification configuration to be used by the BS 901.

In some embodiments, step 910 may be an optional step. For example, step 910 may be performed by another network device (e.g., another BS, AI/ML model training device), but not by the BS 902. In another example, the sparsification configuration may be predetermined.

At step 920, the BS 902 may transmit, to the UE 901, information indicative of the sparsification configuration. In some embodiments, the BS 902 may determine the sparsification configuration based on at least one of computing capability of the UE 901 or uplink (UL) channel quality.

In some embodiments, the BS 902 may configure or determine more than one sparsification configuration. The BS 902 may configure or determine which sparsification configuration may be associated with each layer for which sparsification is enabled during the AI/ML model training iteration. Then, the BS 902 may indicate, to the UE 901, the sparsification configuration associated with each layer for which sparsification is enabled. For example, the BS 902 may transmit the information indicative of the sparsification configuration associated with each sparsification-enabled layer using a downlink control information (DCI) signaling, a media access control-control element (MAC-CE) signaling, or a radio resource control (RRC) signaling. In some embodiments, the BS 902 may determine which sparsification configuration is associated with each sparsification-enabled layer according to one or more predetermined rules.

It should be noted that while the following steps 930-970 are illustrated using a uniform sparsification configuration and associated KI that are configured or determined by a BS, these steps may be performed in some embodiments using a different sparsification configuration such as a non-uniform sparsification configuration.

At step 930, the BS 902 may transmit a global AI/ML model (e.g., common AI/ML model or a sparse AI/ML model) to the UE 901. The global AI/ML model may be transmitted from the BS 902 to the UE 901 by broadcast, groupcast, or unicast signaling.

In some embodiments, the BS 902 may transmit full parameters for each layer of the global AI/ML model (e.g., parameters of common AI/ML model). Put another way, the BS 902 may transmit NN parameters associated with all neurons in each NN layer to the UE 901.

In some embodiments, the BS 902 may transmit partial parameters for each layer of the global AI/ML model (e.g., parameters of sparse AI/ML model). Put another way, the BS 902 may transmit only some or partial NN parameters of the global AI/ML model that are associated with a certain sparsification configuration. For example, the BS 902 may transmit only the NN parameters associated with a particular sparsification configuration SVi, where the sparsification configuration SVi has a certain KI value (e.g., KI=N) and is associated with a certain AI/ML model training iteration. In some embodiments, the sparsification configuration and/or the KI may be indicated to the UE 901 through a UE-specific signaling specific to the UE 901, a group-specific signaling specific to a group of UEs to which the UE 901 belongs, or a cell-specific signaling specific to a cell associated with the UE 901.

In some embodiments, step 930 may be an optional step.

In some embodiments, step 930 may be considered part of step 940 or step 950.

At step 940, the UE 901 may configure the NN based on the sparsification configuration. The sparsification configuration may be obtained based on the information received at step 920 (e.g., information indicative of the sparsification configuration).

As noted above, in some embodiments, step 930 may be part of step 940. In such case, the UE 901, at step 940 (i.e., configuring the NN), may generate a local AI/ML model using the sparsification configuration and the global AI/ML model (e.g., common AI/ML model or sparse AI/ML model) received from the BS 902 at step 930. In some embodiments, the local AI/ML model generated by the UE 901 may be a sub-AI/ML model. The UE 901 may generate the sub-AI/ML model according to the sparsification configuration. The sparsification configuration may include an associated KI and information related to connected neurons in each neuron group in each layer of the NN. Put another way, the sub-AI/ML model may be generated based on a KI associated with the sparsification configuration and information related to connected neurons that is indicated or included in the sparsification configuration.

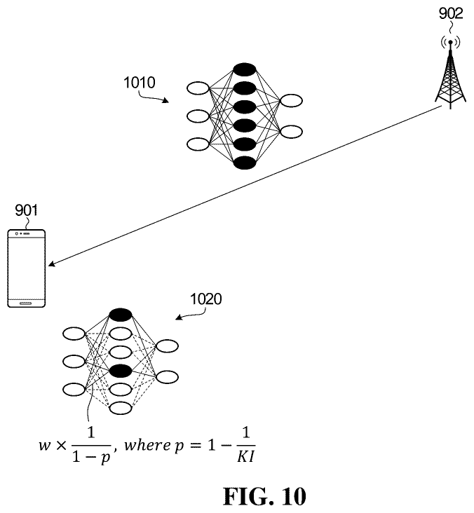

One example for generating a sub-AI/ML model is illustrated in FIG. 10. Referring to FIG. 10, the BS 902 may transmit a global AI/ML model 1010 to the UE 901. The UE 901 may generate a sub-AI/ML model 1020 based on the received the global AI/ML model 1010. For example, the UE 901 may keep some of the neurons and connections between the neurons included in the received global AI/ML model 1010 according to the sparsification configuration. The sparsification configuration may include an associated KI and information related to connected neurons in each neuron group in each layer of the NN. Put another way, the sub-AI/ML model may be generated based on a KI associated with the sparsification configuration and information related to connected neurons that is indicated or included in the sparsification configuration. The kept neurons may be considered connected neurons. The sub-AI/ML model 1020 generated by the UE 901 may include only the connected neurons and their associated connections, as shown in FIG. 10. The connected neurons and their associated connections may be part of the global AI/ML model 1010. Put another way, the sub-AI/ML model 1020 may be a sub-AI/ML model of the global AI/ML model 1010. In some embodiments, the connections associated with the connected neurons in the sub-AI/ML model 1020 (e.g., connections kept in the sub-AI/ML model 1020) may be weighted, for example by a weight w. The weight w for the connections associated with the connected neurons may be scaled by a factor

$$\frac{1}{1 - p} ,$$

where

$$p = 1 - \frac{1}{KI}$$

and KI=keep interval.

In some embodiments, step 940 may be an optional step. For example, the NN may not need to be configured according to the sparsification configuration as the UE 901 may perform a full AI/ML model training at step 950.

At step 950, the UE 901 may perform an AI/ML model training using the NN to obtain one or more NN parameters that may be transmitted to the BS 902.

In some embodiments, when the BS 902 transmits, to the UE 901, full parameters for each layer of the global AI/ML model (e.g., parameters of common AI/ML model) at step 930, the UE 901, as noted above, may generate a local AI/ML model (e.g., sub-AI/ML model) using the sparsification configuration and the global AI/ML model (e.g., common AI/ML model or sparse AI/ML model) received from the BS 902 at step 930. In such cases, the UE 901 may train the generated local AI/ML (e.g., sub-AI/ML model 1020) model using a local AI/ML model training dataset of the UE 901. The NN structure of the generated local AI/ML model may be different from the NN structure of the global AI/ML model received from the BS 902. After the training of the local AI/ML, the UE 901 may obtain updated NN parameters, for example updated gradients of the connections or updated weights of the connections.

In some embodiments, when the BS 902 transmits, to the UE 901, full parameters for each layer of the global AI/ML model (e.g., parameters of common AI/ML model) at step 930, the UE 901 may not generate a local AI/ML model or a sub-AI/ML model. Instead, the UE 901 may train a local AI/ML model whose NN structure of the local AI/ML model is same as the NN structure of the global AI/ML model received from the BS 902 at step 930, using a local AI/ML model training dataset. Given that the NN structure of the local AI/ML model is same as the NN structure of the global AI/ML model, this type of training may be considered a full AI/ML model training.

In some embodiments, when the BS 902 transmits, to the UE 901, only some or partial parameters for each layer of the global AI/ML model (e.g., parameters of sparse AI/ML model) at step 930, the UE 901 may train the received global AI/ML model (e.g., received sparse AI/ML model) using a local AI/ML model training dataset. In such case, the UE 901 may not need to rely on the sparsification configuration for the purpose of AI/ML model training.

In some embodiments, step 950 may be an optional step. For example, step 950 may be performed by another user device (e.g., another UE, AI/ML model training device), but not by the UE 901. In such case, the UE 901 may only obtain the updated or trained NN parameters after the AI/ML model training process.

At step 960, the UE 901 may transmit some or all of the updated or trained NN parameters to the BS 902.

In some embodiments where the UE 901 performs a full AI/ML model training, the UE 901 may update or train all NN parameters but transmit, to the BS 902, only one or more NN parameters that are associated with connected neurons according to the sparsification configuration.

In some embodiments where the UE 901 performs an AI/ML model training according to the sparsification configuration (e.g., training a sub-AI/ML model generated based on the sparsification configuration), the UE 901 may transmit, to the BS 902, only one or more NN parameters that are associated with connected neurons according to the sparsification configuration.

Put another way, regardless of the type of AI/ML model training, the UE 901 may transmit, to the BS 902, only one or more NN parameters that are associated with connected neurons according to the sparsification configuration.

After receiving updated NN parameters of the local AI/ML model (e.g., NN parameters associated with connected neurons) from the UE 901 (and/or one or more other UEs), the BS 902, at step 970, may perform AI/ML model aggregation to generate an updated AI/ML global model. All neurons in the NN may be connected neurons at the BS 902. In some embodiments, the BS 902 may perform a global AI/ML model training such that the BS 902 may generate a common AI/ML model Kᵢ for each sub-AI/ML model kᵢ, and obtain the updated global AI/ML model by averaging the generated common AI/ML models.

In some embodiments, step 970 may be an optional step.

As noted above, in some embodiments where a uniform sparsification configuration is used, only one neuron may be a connected neuron in each neuron group. Therefore, for each layer of the NN, there may be as many sparsification configurations as there are neurons per neuron group. For example, there may be a total of N (when KI=N) sparsification configurations or N sparsification versions (SVs). As the KI is N, the available range for the index for sparsification configuration may be from 0 to N−1 or 0 to N. In any case, the indices 0 to N−1 may be used for each sparsification configuration. For example, each sparsification configuration may be denoted as SV0, SV1, . . . , SVN−1. Each of the indices 0 to N−1 may indicate the location of the only one connected neuron within each neuron group. When the available range for the index is from 0 to N, the index N may be used to indicate that the sparsification is disabled for the NN layer to which the neuron group belongs.

According to some embodiments, a sparsification configuration may be indicative of one or more iterations of the AI/ML model training associated with the sparsification configuration. For example, a BS may indicate, to a UE, a uniform sparsification configuration including the KI and the connected neuron in the neuron group for one or more iterations of the AI/ML model training using a DCI signaling, a MAC-CE signaling, or a RRC signaling.

In some embodiments, a BS may determine the sparsification configuration based on at least one of capability of the UE, a scheduled MCS, the number of scheduled resource blocks, the number of scheduled layers, a carrier frequency, or a CQI reported by the UE. For example, when a BS observes changes related to computing capability of the UE or the UL channel quality, the BS may indicate a suitable sparsification configuration that reflects the computing capability of the UE and/or the UL channel quality. In another example, when a BS observes overfitting occurring in one or more NN layer at a UE, the BS may indicate a suitable sparsification configuration to the UE so that the UE may train a sparser AI/ML model and improve AI/ML model training performance (e.g., generalization performance).

In some embodiments, an AI/ML model training may include multiple iterations and the sparsification configuration may include a sparsification configuration pattern. The sparsification configuration pattern may be indicative of a respective sparsification configuration associated with one or more iterations of the AI/ML model training.

For example, a BS may determine a sparsification configuration that includes a sparsification configuration pattern for multiple iterations (m iterations). The sparsification configuration pattern may include a sequence of multiple sparsification configurations with a length of m (i.e., the length of the sequence of sparsification configurations=the number of iterations). In some embodiments, the sparsification configuration pattern may be a cyclic repetition of the sequence of multiple sparsification configurations according to the sparsification configuration pattern.

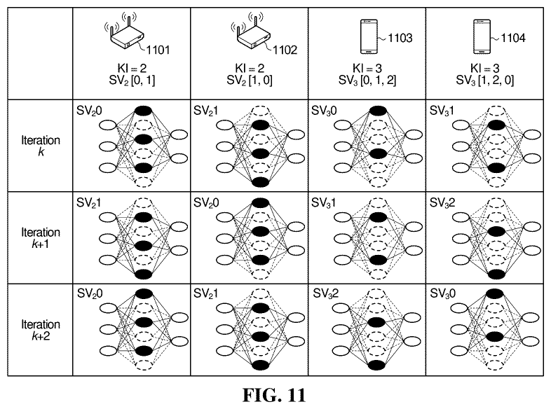

Example sparsification configuration patterns for multiple iterations of an AI/ML model training are illustrated in FIG. 11. Referring to FIG. 11, a sparsification configuration pattern SV₂ [0, 1] is indicated for the UE 1101. SV₂ may be indicative of a uniform sparsification configuration where the size of each neuron group is 2 (i.e., KI=2). The sparsification configuration pattern SV₂ [0, 1] may indicate that, for example, at iteration k, the UE 1101 may perform an AI/ML model training and reporting according to a sparsification configuration SV₂0 (i.e., the first sparsification configuration in the sparsification configuration pattern), and at iteration k+1, the UE 1101 may perform an AI/ML model training and reporting according to a sparsification configuration SV₂1 (i.e., the second sparsification configuration in the sparsification configuration pattern). When the sparsification configuration pattern may be a cyclic repetition of the sequence of multiple sparsification configurations, the UE 1101, at iteration k+2, may perform an AI/ML model training and reporting according to the sparsification configuration SV₂0 again. The sparsification configuration SV₂0 may be indicative of a sparsification configuration SV0 where the KI is 2. Put another way, the sparsification configuration SV₂0 may indicate that the number of consecutive neurons in each neuron group is 2 (i.e., KI=2) and that the first neuron (e.g., index=0) in each neuron group of the NN layer is the only one connected neuron in the neuron group. In a similar way, the sparsification configuration SV₂1 may be indicative of a sparsification configuration SV1 where the KI is 2. Therefore, the number of consecutive neurons in each neuron group is 2 (i.e., KI=2) and the second neuron (e.g., index=1) in each neuron group of the NN layer is the only one connected neuron in the neuron group.

In some embodiments, a different sparsification configuration may be indicated for each UE. For example, referring to FIG. 11, a sparsification configuration pattern SV₂ [1, 0] is indicated for the UE 1102, a sparsification configuration pattern SV₂ [1, 0] is indicated for the UE 1102, a sparsification configuration pattern SV₃ [0, 1, 2] is indicated for the UE 1103, and a sparsification configuration pattern SV₃ [1, 2, 0] is indicated for the UE 1104. Similar to SV₂, SV₃ may be indicative of a uniform sparsification configuration where the size of each neuron group is 3 (i.e., KI=3).

The sparsification configuration pattern SV₂ [1, 0] may indicate that, for example, at iteration k, the UE 1102 may perform an AI/ML model training and reporting according to the sparsification configuration SV₂1, and at iteration k+1, the UE 1101 may perform an AI/ML model training and reporting according to the sparsification configuration SV₂0. At iteration k+2, the UE 1101 may perform an AI/ML model training and reporting according to the sparsification configuration SV₂1 again.

The sparsification configuration pattern SV₃ [0, 1, 2] may indicate that, for example, at iteration k, the UE 1103 may perform an AI/ML model training and reporting according to a sparsification configuration SV₃0 (i.e., the first sparsification configuration in the sparsification configuration pattern), and at iteration k+1, the UE 1103 may perform an AI/ML model training and reporting according to a sparsification configuration SV₃1 (i.e., the second sparsification configuration in the sparsification configuration pattern). At iteration k+2, the UE 1103 may perform an AI/ML model training and reporting according to a sparsification configuration SV₃2 (i.e., the third sparsification configuration in the sparsification configuration pattern). The sparsification configuration SV₃0 may be indicative of a sparsification configuration SV0 where the KI is 3. Put another way, the sparsification configuration SV₃0 may indicate that the number of consecutive neurons in each neuron group is 3 (i.e., KI=3) and that the first neuron (e.g., index=0) in each neuron group of the NN layer is the only one connected neuron in the neuron group. In a similar way, the sparsification configuration SV₃1 may be indicative of a sparsification configuration SV1 where the KI is 3. Therefore, the number of consecutive neurons in each neuron group is 3 (i.e., KI=3) and the second neuron (e.g., index=1) in each neuron group of the NN layer is the only one connected neuron in the neuron group. The sparsification configuration SV₃2 may be indicative of a sparsification configuration SV₂ where the KI is 3. Therefore, the number of consecutive neurons in each neuron group is 3 (i.e., KI=3) and the third neuron (e.g., index=2) in each neuron group of the NN layer is the only one connected neuron in the neuron group.

The sparsification configuration pattern SV₃ [1, 2, 0] may indicate that, for example, at iteration k, the UE 1104 may perform an AI/ML model training and reporting according to the sparsification configuration SV₃1, and at iteration k+1, the UE 1104 may perform an AI/ML model training and reporting according to the sparsification configuration SV₃2. At iteration k+2, the UE 1104 may perform an AI/ML model training and reporting according to the sparsification configuration SV₃0.

According to some embodiments, using sparsification configuration patterns for multiple iterations (e.g., m iterations), overhead for indicating sparsification configuration (e.g., overhead for index of sparsification configuration) may be reduced.

In some embodiments, given that different sparsification configurations may be indicated for different UEs, respectively, a BS may acquire information related to all neurons (e.g., all NN parameters) at once (or with less iterations) as multiple UEs may collectively transmit information related to all neurons (or a greater number of neurons) at once. For example, referring to FIG. 11, at iteration k, the UE 1101 may transmit information related to neurons associated with SV₂0 and the UE 1102 may transmit information related to neurons associated with SV₂1. Therefore, the BS may acquire information related to all neurons more quickly, for example by combining information received from the UEs 1101 and 1102, to update a global AI/ML model.

In some embodiments, a BS may implicitly determine or configure a sparsification configuration and an associated KI based on one or more factors, such as a scheduled MCS, the number of scheduled resource blocks, the number of scheduled layers, a carrier frequency, and/or a CQI reported by the UE. For this, a BS may determine or configure one or more mappings between the one or more factors and the sparsification configuration and the associated KI. The BS may implicitly determine or configure the sparsification configuration and the associated KI based on the one or more mappings. For example, the BS may determine that a particular sparsification configuration SVl may be indicated to the UE when the number of scheduled layers is l, as there is the sparsification configuration SVl is mapped to (associated with) cases where the number of scheduled layers is l.

In some embodiments, a UE may determine a sparsification configuration and an associated KI for an AI/ML model training. For example, a UE may transmit, to an associated BS, a sparsification configuration, which may include an associated KI and an index of the sparsification configuration in the sparsification configuration pattern, when the UE reports the updated or trained NN parameters to the BS. In some embodiments, the sparsification configuration may be transmitted in a header of the UE's report for the updated NN parameters.

By virtue of some aspects of the present disclosure, AI/ML processing delays or computation delays in AI/ML model training processes (e.g., FL-based AI/ML model training processes) may be reduced, as a reduced number of NN parameters may be trained by a UE according to a sparsification configuration, for example compared to the conventional FL-based AI/ML model training processes.

By virtue of some aspects of the present disclosure, UL transmission overhead and computation or processing delays in AI/ML model training processes (e.g., FL-based AI/ML model training processes) may be reduced, as a reduced NN parameters trained/updated by a UE may be transmitted to a BS according to a sparsification configuration, for example compared to the conventional FL-based AI/ML model training processes.

By virtue of some aspects of the present disclosure, air interface overhead and delays in AI/ML model training processes (e.g., FL-based AI/ML model training processes) may be reduced without degrading AI/ML model inference performance (e.g., accuracy).

Examples of devices (e.g. ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein, e.g. in relation to FIG. 9. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

DEFINITIONS OF ACRONYMS

| | |
|---|---|
| AI | Artificial intelligence |
| LTE | Long Term Evolution |
| NR | New Radio |
| BWP | Bandwidth part |
| BS | Base Station |
| CA | Carrier Aggregation |
| CC | Component Carrier |
| CG | Cell Group |
| CSI | Channel state information |
| CSI-RS | Channel state information Reference Signal |
| DNN | Deep neutral network |
| DC | Dual Connectivity |
| DCI | Downlink control information |
| DL | Downlink |
| DL-SCH | Downlink shared channel |
| EN-DC | E-UTRA NR dual connectivity with MCG using E-UTRA |
| | and SCG using |
| gNB | Next generation (or 5G) base station |
| HARQ-ACK | Hybrid automatic repeat request acknowledgement |
| MCG | Master cell group |
| MCS | Modulation and coding scheme |
| MAC-CE | Medium Access Control-Control Element |
| PBCH | Physical broadcast channel |
| PCell | Primary cell |
| PDCCH | Physical downlink control channel |
| PDSCH | Physical downlink shared channel |
| PRACH | Physical Random Access Channel |
| PRG | Physical resource block group |
| PSCell | Primary SCG Cell |
| PSS | Primary synchronization signal |
| PUCCH | Physical uplink control channel |
| PUSCH | Physical uplink shared channel |
| RACH | Random access channel |
| RAPID | Random access preamble identity |
| RB | Resource block |
| RE | Resource element |
| RRM | Radio resource management |
| RMSI | Remaining system information |
| RS | Reference signal |
| RSRP | Reference signal received power |
| RRC | Radio Resource Control |
| SCG | Secondary cell group |
| SFN | System frame number |
| SL | Sidelink |
| SCell | Secondary Cell |
| SPS | Semi-persistent scheduling |
| SR | Scheduling request |
| SRI | SRS resource indicator |
| SRS | Sounding reference signal |
| SSS | Secondary synchronization signal |
| SSB | Synchronization Signal Block |
| SUL | Supplement Uplink |
| TA | Timing advance |
| TAG | Timing advance group |
| TUE | Target UE |
| UCI | Uplink control information |
| UE | User Equipment |
| UL | Uplink |
| UL-SCH | Uplink shared channel |

What is claimed is:

1. A method, comprising:
receiving, by a user equipment (UE) from a base station (BS), information indicative of a sparsification configuration for one or more layers of a neural network (NN), the sparsification configuration indicative of at least one of:
whether sparsification is enabled for a respective layer, or
for each neuron in the respective layer, whether the neuron is connected or disconnected to another neuron in another layer of the NN; and
transmitting, by the UE to the BS, one or more NN parameters associated with one or more connected neurons according to the sparsification configuration.

2. The method of claim 1, wherein the respective layer includes one or more neuron groups, each neuron group comprising a set of consecutive neurons determined based on a keep interval (KI) indicative of the number of the consecutive neurons in the neuron group, each neuron group including only one connected neuron, the KI and the only one connected neuron in each group being included in the sparsification configuration.

3. The method of claim 2, wherein a location of the only one connected neuron in each neuron group is different.

4. The method of claim 3, wherein the only one connected neuron in each neuron group is indicated by an index, the index indicative of at least one of:
the location of the only one connected neuron within each neuron group; or
whether sparsification is enabled for the respective layer.

5. The method of claim 1, further comprising:
configuring, by the UE, the NN based on the sparsification configuration, to obtain a configured NN; and
performing, by the UE, artificial intelligence or machine learning (AI/ML) model training using the configured NN and using a local AI/ML model training dataset to obtain the one or more NN parameters.

6. The method of claim 5, wherein configuring the NN comprises:
receiving, by the UE from the BS, a global AI/ML model; and
generating, by the UE, a local AI/ML model using the sparsification configuration and the received global AI/ML model.

7. The method of claim 1, further comprising:
performing artificial intelligence or machine learning (AI/ML) model training, wherein the AI/ML model training includes multiple iterations and the sparsification configuration includes a sparsification configuration pattern, the sparsification configuration pattern indicative of a respective sparsification configuration associated with one or more iterations of the AI/ML model training.

8. The method of claim 7, wherein the sparsification configuration pattern is a cyclic repetition of a sequence of multiple sparsification configurations.

9. A user equipment (UE) comprising:
at least one processor; and
at least one memory storing processor-executable instructions that, when executed, cause the at least one processor to:
receive, from a base station (BS), information indicative of a sparsification configuration for one or more layers of a neural network (NN), the sparsification configuration indicative of at least one of:
whether sparsification is enabled for a respective layer of the one or more layers, or
for each neuron in the respective layer, whether the neuron is connected or disconnected to another neuron in another layer of the NN; and
transmit, to the BS, one or more NN parameters associated with one or more connected neurons according to the sparsification configuration.

10. The UE of claim 9, wherein the respective layer includes one or more neuron groups, each neuron group comprising a set of consecutive neurons determined based on a keep interval (KI) indicative of the number of the consecutive neurons in the neuron group, each neuron group including only one connected neuron, the KI and the only one connected neuron in each group being included in the sparsification configuration.

11. The UE of claim 10, wherein a location of the only one connected neuron in each neuron group is different.

12. The UE of claim 11, wherein the only one connected neuron in each neuron group is indicated by an index, the index indicative of at least one of:
the location of the only one connected neuron within each neuron group; or
whether sparsification is enabled for the respective layer.

13. The UE of claim 9, wherein the processor-executable instructions further comprise processor-executable instructions that, when executed, cause the processor to:
configure the NN based on the sparsification configuration, to obtain a configured NN; and
perform artificial intelligence or machine learning (AI/ML) model training using the configured NN and using a local AI/ML model training dataset to obtain the one or more NN parameters.

14. The UE of claim 13, wherein configuring the NN comprises:
receiving, by the UE from the BS, a global AI/ML model; and
generating, by the UE, a local AI/ML model using the sparsification configuration and the received global AI/ML model.

15. A method, comprising:
transmitting, by a base station (BS) to a user equipment (UE), information indicative of a sparsification configuration for at least one layer of a neural network (NN), the sparsification configuration indicative of at least one of:
whether sparsification is enabled for a respective layer of the one or more layers, or
for each neuron in the respective layer, whether the neuron is connected or disconnected to another neuron in another layer of the NN; and
receiving, by the BS from the UE, one or more NN parameters associated with one or more connected neurons according to the sparsification configuration.

16. The method of claim 15, wherein the respective layer includes one or more neuron groups, each neuron group comprising a set of consecutive neurons determined based on a keep interval (KI) indicative of the number of the consecutive neurons in the neuron group, each neuron group including only one connected neuron, the KI and the only one connected neuron in each group being included in the sparsification configuration.

17. The method of claim 16, wherein a location of the only one connected neuron in each neuron group is different.

18. The method of claim 16, wherein the only one connected neuron in each neuron group is indicated by an index, the index indicative of at least one of:
a location of the only one connected neuron within each neuron group; or
whether sparsification is enabled for the respective layer.

19. The method of claim 15, further comprising:
performing artificial intelligence or machine learning (AI/ML) model training, wherein the AI/ML model training includes multiple iterations and the sparsification configuration includes a sparsification configuration pattern, the sparsification configuration pattern indicative of a respective sparsification configuration associated with one or more iterations of the AI/ML model training.

20. The method of claim 19, wherein the sparsification configuration pattern is a cyclic repetition of a sequence of multiple sparsification configurations.
